(19) United States
(12) Patent Application Publication
(10) Pub. No.: US 2007/0053038 A1
(43) Pub. Date: Mar. 8, 2007

(54) Laser scanner assembly

(76) Inventor: Douglas G. Keithley, Austin, TX (US)

Correspondence Address: BRINKS HOFER GILSON & LIONE/MARVELL, P.O. BOX 10395, CHICAGO, IL, 60610, US

(21) Appl. No.: 11/220,960

(22) Filed: Sep. 7, 2005

(51) Int. Cl. G02B 26/08

(52) U.S. Cl. 359/204; 359/216

(57) ABSTRACT

A laser scanner assembly comprising a rotating mirror, a first laser unit configured to generate at least a first laser beam, and a second laser unit configured to generate at least a second laser beam is provided. The rotating mirror is configured to direct the first laser beam along a first optical path during a first time period and along a second optical path during a second time period that is subsequent to the first time period, and the rotating mirror is configured to direct the second laser beam along a third optical path during the first time period and along a fourth optical path during the second time period.

### BACKGROUND

Image forming systems are typically configured to generate images and transfer these images to a medium. For example, a laser printer may generate an image on a photoconductor drum using a laser and transfer the image from the photoconductor drum to a medium such as paper. The reduction of costs of an image forming system typically involves decreasing the speed at which the image forming system generates and transfers images. For example, the reduction of costs may involve fewer components or lower performance components. It would be desirable to at least maintain the speed of generating and transferring images in an image forming system while decreasing the number and/or cost of components in the system.

### SUMMARY

One exemplary embodiment provides a laser scanner assembly comprising a rotating mirror, a first laser unit configured to generate at least a first laser beam, and a second laser unit configured to generate at least a second laser beam. The rotating mirror is configured to direct the first laser beam along a first optical path during a first time period and along a second optical path during a second time period that is subsequent to the first time period, and the rotating mirror is configured to direct the second laser beam along a third optical path during the first time period and along a fourth optical path during the second time period.

### BRIEF DESCRIPTION OF THE DRAWINGS

FIG. 1 is a block diagram illustrating one embodiment of an image forming system.

FIG. 2 is a block diagram illustrating additional details of a portion of the image forming system of FIG. 1 according to one embodiment.

FIG. 3A-3D are diagrams illustrating various perspectives of one embodiment of a rotating mirror.

FIGS. 4A-4B are diagrams illustrating selected portions of one embodiment of a laser scanner assembly.

FIG. 5 is a diagram illustrating selected portions of one embodiment of a laser scanner assembly.

FIG. 6 is a diagram illustrating selected portions of one embodiment of a laser scanner assembly.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

As described herein, a laser scanner assembly is provided. The laser scanner assembly includes two laser units and a rotating mirror according to one embodiment. The rotating mirror directs a first laser beam from one of the laser units along first and second optical paths during alternating time periods to discharge selected portions of first and second photoconductor drums, respectively. The rotating mirror also directs a second laser beam from the other laser unit along third and fourth optical paths during the alternating time periods, simultaneous with directing the first laser beam, to discharge selected portions of third and fourth photoconductor drums, respectively. The laser scanner assembly may be included in an image forming system such as a color laser printer.

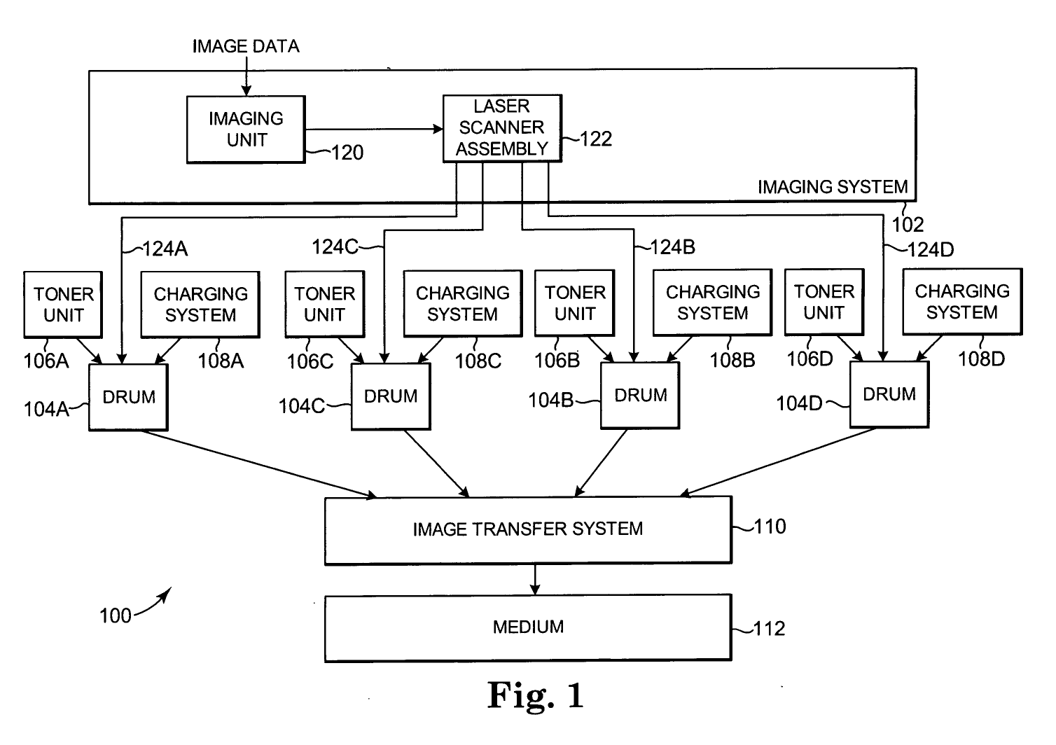

FIG. 1 is a block diagram illustrating one embodiment of an image forming system 100. Image forming system 100 includes an imaging system 102, four photoconductor drums 104A, 104B, 104C, and 104D (referred to individually as photoconductor drum 104 or collectively as photoconductor drums 104), four toner units 106A, 106B, 106C, and 106D (referred to individually as toner unit 106 or collectively as toner units 106), four charging systems 108A, 108B, 108C, and 108D (referred to individually as charging system 108 or collectively as charging systems 108), an image transfer system 110, and a medium 112. Image generation system 102 includes an imaging unit 120 and a laser scanner assembly 122.

Imaging system 102 is a laser imager configured to create latent images on photoconductor drums 104. Charging systems 108 are configured to negatively charge respective photoconductor drums 104 as photoconductor drums 104 rotate or otherwise move past charging systems 108. Imaging unit 120 receives image data and causes laser scanner assembly 122 to project laser beams onto selected areas of photoconductor drums 104 to discharge the selected areas as photoconductor drums 104 rotate or otherwise move relative to laser scanner assembly 122. The discharged areas of photoconductor drums 104 comprise the latent images.

Toner units 106 each include a developer (not shown) and toner (not shown) of a selected color, e.g., cyan, magenta, yellow, or black. In response to being activated, a toner unit 106 develops toner using the developer. As discharged areas of photoconductor drums 104 move over respective activated toner units 106, toner transfers from the developer in respective toner units 106 to discharged areas of photoconductor drums 104, respectively, to create a single color image on each photoconductor drum 104.

Image transfer system 110 operates to transfer the single color images from photoconductor drums 104 to medium 112. In one embodiment, image transfer system 110 includes a transfer belt (not shown) that moves past photoconductor drums 104 to receive the single color images from each photoconductor drum 104. Subsequent to receiving all of the single color images from photoconductor drums 104, image transfer system 110 transfers a combined image that includes all of the single color images to medium 112. In other embodiments, image transfer system 110 may include other transfer components or may operate to cause the single color images to be transferred directly from photoconductor drums 104 to medium 112. Medium 112 may comprise any suitable medium configured to receive images from photoconductor drums 104 such as paper, transparency sheets, envelopes, and adhesive sheets.

In one embodiment, image forming system 100 comprises an in-line color laser printer where toner unit 106A, 106B, 106C, and 106D include cyan toner, magenta toner, yellow toner, and black toner, respectively.

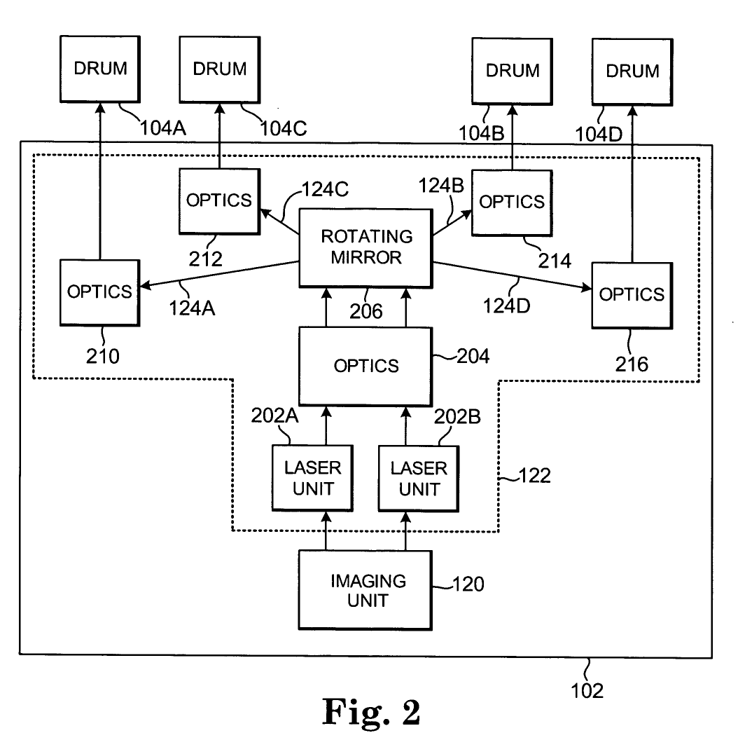

FIG. 2 is a block diagram illustrating additional details of a portion of image forming system 100 of FIG. 1 according to one embodiment. In FIG. 2, laser scanner assembly 122 includes laser units 202A and 202B, optics 204, 210, 212, 214, and 216, and rotating mirror 206.

In operation, imaging unit 120 causes each of laser units 202A and 202B to selectively emit one or more laser beams through optics 204 and onto rotating mirror 206 according to received image data. Optics 204 collimate and focus the laser beams from laser units 202A and 202B onto rotating mirror 206. Rotating mirror 206 reflects the laser beam from laser unit 202A along optical paths 124A and 124C during alternating time periods, and, simultaneously with reflecting the laser beam from laser unit 202A, rotating mirror 206 reflects the laser beam from laser unit 202B along optical paths 124B and 124D during the alternating time periods.

In one embodiment, rotating mirror 206 reflects the laser beam from laser unit 202A along optical path 124A through optics 210 and onto photoconductor drum 104A during a first time period. In addition, rotating mirror 206 reflects the laser beam from laser unit 202B along optical path 124B through optics 214 and onto photoconductor drum 104B during the first time period. In the first time period, optics 210 and 214 collimate and focus the laser beams from laser units 202A and 202B, respectively, onto photoconductor drums 104A and 104B, respectively. Rotating mirror 206 rotates continuously during the first time period to cause the laser beams from laser units 202A and 202B to scan across photoconductor drums 104A and 104B, respectively, to selectively discharge one or more lines of photoconductor drums 104A and 104B.

During a second time period that is subsequent to the first time period, rotating mirror 206 reflects the laser beam from laser unit 202A along optical path 124C through optics 212 and onto photoconductor drum 104C. In addition, rotating mirror 206 reflects the laser beam from laser unit 202B along optical path 124D through optics 216 and onto photoconductor drum 104D during the second time period. Rotating mirror 206 rotates continuously during the second time period to cause the laser beams from laser units 202A and 202B to scan across photoconductor drums 104C and 104D, respectively, to selectively discharge one or more lines of photoconductor drums 104C and 104D.

In a third time period that is subsequent to the second time period, rotating mirror 206 functions as in the first time period to cause the laser beams from laser units 202A and 202B to scan across photoconductor drums 104A and 104B, respectively, and selectively discharge one or more lines of photoconductor drums 104A and 104B. Similarly, in a fourth time period that is subsequent to the third time period, rotating mirror 206 functions as in the second time period to cause the laser beams from laser units 202A and 202B to scan across photoconductor drums 104C and 104D, respectively, to selectively discharge one or more lines of photoconductor drums 104C and 104D. Rotating mirror 206 continuously repeats the functions of the first, second, third and fourth time periods in succession during operation of image generation system 102 according to one embodiment.

In one embodiment, laser units 202A and 202B each include dual-laser diodes (not shown) such that each laser unit 202A and 202B is configured to selectively discharge two lines of selected photoconductor drums 104 simultaneously. In other embodiments, laser units 202A and 202B each include n diodes such that each laser unit 202A and 202B is configured to selectively discharge n lines of selected photoconductor drums 104 simultaneously where n is greater than or equal to one.

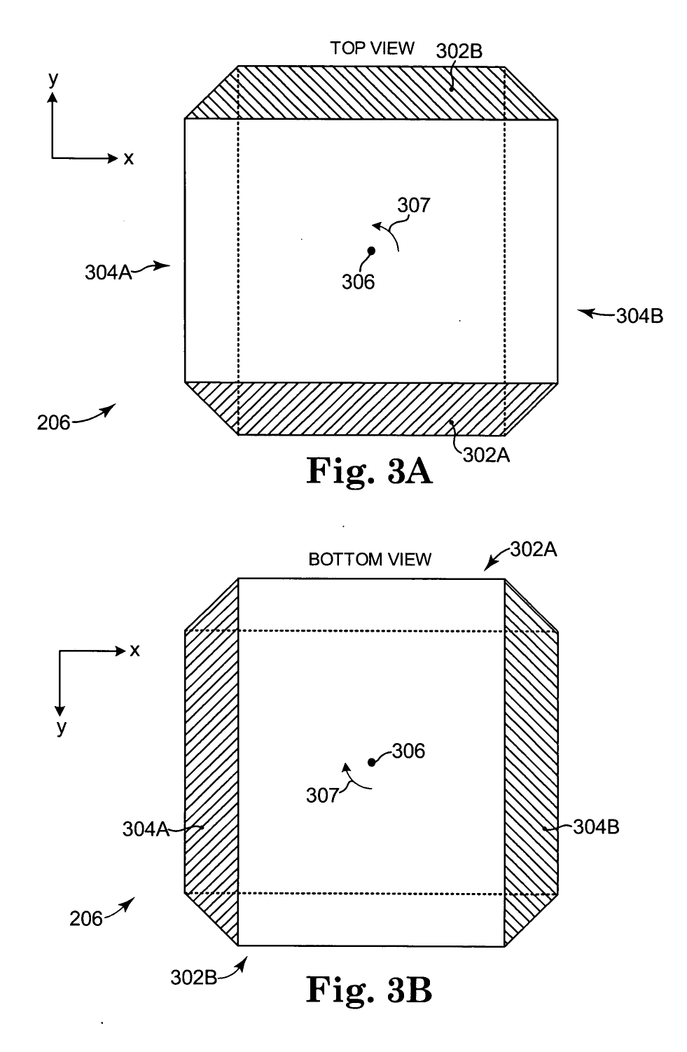

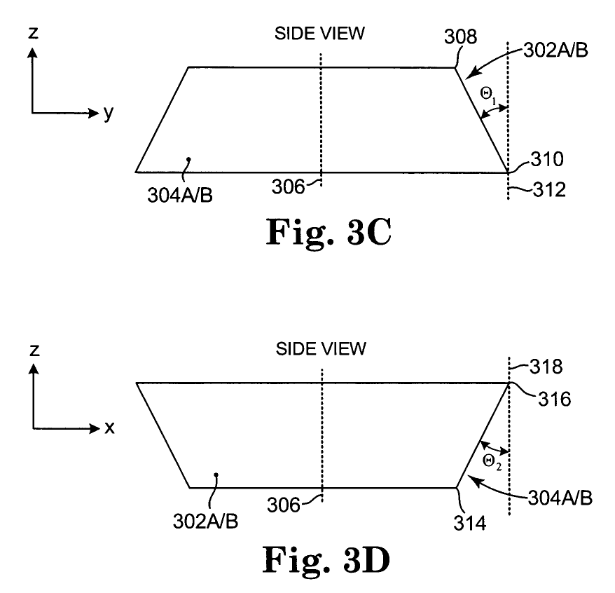

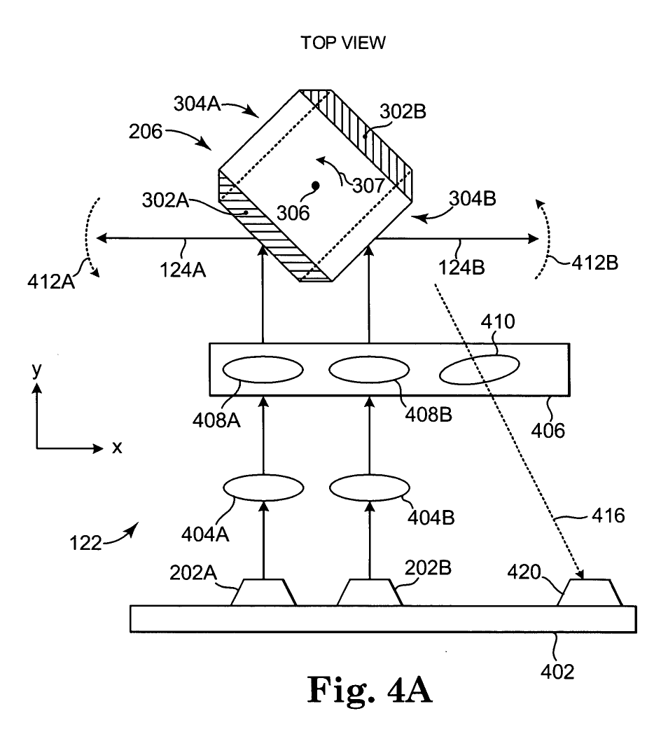

FIG. 3A-3D are diagrams illustrating various perspectives of one embodiment of rotating mirror 206. As shown in the top view of FIG. 3A and the bottom view of FIG. 3B in the x and y plane, rotating mirror 206 includes a pair of beveled facets 302A and 302B along one set of opposite sides of rotating mirror 206 and a pair of beveled facets 304A and 304B along the other set of opposite sides of rotating mirror 206. Rotating mirror 206 is configured to rotate around an axis of rotation 306 in the direction indicated by an arrow 307.

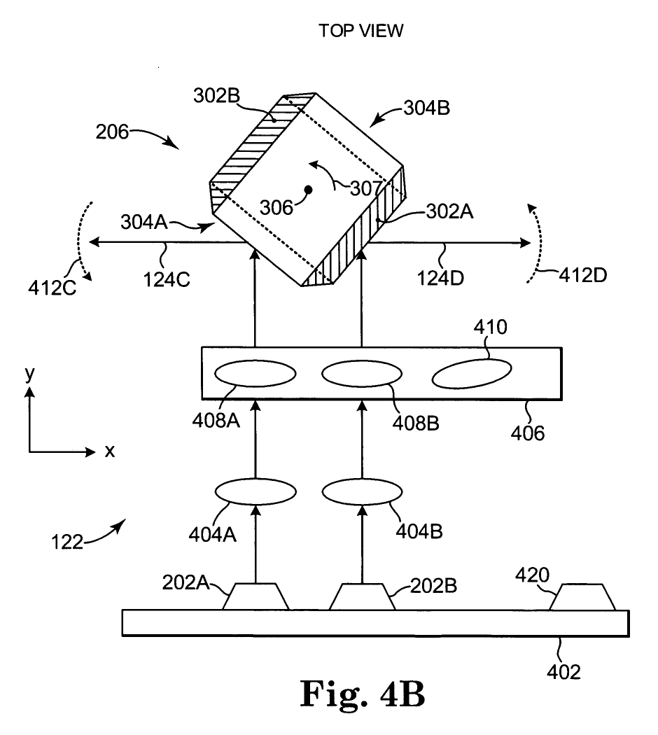

FIG. 3C illustrates a side view of facet 304A or 304B in they and z plane. As shown in FIG. 3C, each facet 302A and 302B is beveled such that each facet 302A and 302B includes an inner edge 308 and an outer edge 310 relative to axis of rotation 306. Each facet 302A and 302B forms an angle θ₁ between a hypothetical plane 312 that is parallel to axis of rotation 306 and is parallel to and intersects outer edge 310 of facet 302A or 302B, wherein θ₁ is between positive ninety degrees and negative ninety degrees. In one embodiment, θ₁ is approximately fifteen degrees. In this configuration, facets 302A and 302B are configured to reflect laser beams at least partially in a positive z direction where the positive z direction is towards the top of FIGS. 3C and 3D. The positive z direction will be referred to as “upward” or out from the page when viewed from a top view of laser scanner assembly 122 herein (e.g., FIGS. 3A, 4A, and 4B).

FIG. 3D illustrates a side view of facet 302A or 302B in the x and z plane. As shown in each facet 304A and 304B is beveled such that each facet 304A and 304B includes an inner edge 314 and an outer edge 316 relative to axis of rotation 306. Each facet 304A and 304B forms an angle θ₂ between a hypothetical plane 312 that is parallel to axis of rotation 306 and is parallel to and intersects outer edge 316 of facet 304A or 304B, wherein θ₂ is between positive ninety degrees and negative ninety degrees. In one embodiment, θ₂ is approximately fifteen degrees. In this configuration, facets 304A and 304B are configured to reflect laser beams at least partially in a negative z direction where the negative z direction is towards the bottom of FIGS. 3C and 3D. The negative z direction will be referred to as “downward” or into the page when viewed from a top view of laser scanner assembly 122 herein (e.g., FIGS. 3A, 4A, and 4B).

In the above embodiments, angles θ₁ and θ₂ are selected to ensure that facets 302A and 302B create different optical paths than facets 304A and 304B for each of the laser beams from laser units 202A and 202B. Accordingly, angles θ₁ and θ₂ are selected such that angle θ₁ is not equal the negative of angle θ₂, i.e., angle θ₁≠(angle θ₂). Accordingly, if angle θ₁ is equal to zero, then angle θ₂ is not equal to zero and vice versa. In one embodiment, angle θ₁ is the same or approximately the same as angle θ₂. In other embodiments, angle θ₁ differs from angle θ₂.

In one embodiment, rotating mirror 206 is formed using polished aluminum. In other embodiments, rotating mirror 206 is formed using other reflective materials.

FIGS. 4A-4B are diagrams illustrating a top view of selected portions of one embodiment of laser scanner assembly 122. In the embodiment of FIGS. 4A-4B, laser scanner assembly 122 includes the embodiment of rotating mirror 206 shown in FIGS. 3A-3D. Laser scanner assembly 122 also includes a circuit board 402, lenses 404A and 404B, a lens assembly 406 that includes lenses 408A, 408B, and 410, and a beam detector 420. Circuit board 402 is configured to mount laser units 202A and 202B and a beam detector 420.

Lenses 404A and 408A collimate and focus the laser beam from laser unit 202A onto rotating mirror 206, and lenses 404B and 408B collimate and focus the laser beam from laser unit 202B onto rotating mirror 206. Lenses 404A, 404B, 408A, and 408B comprise optics 204 (as shown in FIG. 2) in one embodiment.

FIG. 4A illustrates the operation of laser scanner assembly 122 during the first time period described above with reference to FIG. 2, and FIG. 4B illustrates the operation of laser scanner assembly 122 during the second time period described above with reference to FIG. 2.

In the embodiment of FIGS. 4A and 4B, laser scanner assembly 122 is configured such that the laser beam from laser unit 202A reflects off of facet 302A of rotating mirror 206 and the laser beam from laser unit 202B reflects off of facet 304B of rotating mirror 206 during the first time period. During the second time period, laser scanner assembly 122 is configured such that the laser beam from laser unit 202A reflects off of facet 304A of rotating mirror 206 and the laser beam from laser unit 202B reflects off of facet 302A of rotating mirror 206. Further, laser scanner assembly 122 is configured such that the laser beam from laser unit 202A reflects off of facet 302B of rotating mirror 206 and the laser beam from laser unit 202B reflects off of facet 304A of rotating mirror 206 during the third time period. In addition, laser scanner assembly 122 is configured such that the laser beam from laser unit 202A reflects off of facet 304B of rotating mirror 206 and the laser beam from laser unit 202B reflects off of facet 302B of rotating mirror 206 during the fourth time period.

As shown in FIG. 4A during the first time period, laser unit 202A selectively emits at least one laser beam through lens 404A and lens 408A onto facet 302A of rotating mirror 206. Similarly, laser unit 202B selectively emits at least one laser beam through lens 404B and lens 408B onto facet 304B of rotating mirror 206.

During the first time period, the laser beam from laser unit 202A reflects off of facet 302A to generate optical path 124A in a partially upward direction (i.e., out from the page in the positive z direction), and the laser beam from laser unit 202B reflects off of facet 304B to generate optical path 124B in a partially downward direction (i.e., into the page in the negative z direction). As rotating mirror 206 rotates around axis of rotation 306 in the direction indicated by arrow 307, the laser beam from laser unit 202A scans across optical path 124A in the direction indicated by an arrow 412A, and the laser beam from laser unit 202B scans across optical path 124B in the direction indicated by an arrow 412B.

As shown in FIG. 4B during the second time period, laser unit 202A selectively emits at least one laser beam through lens 404A and lens 408A onto facet 304A of rotating mirror 206. Similarly, laser unit 202B selectively emits at least one laser beam through lens 404B and lens 408B onto facet 302A of rotating mirror 206.

During the second time period, the laser beam from laser unit 202A reflects off of facet 304A to generate optical path 124C in a partially downward direction (i.e., into the page in the negative z direction), and the laser beam from laser unit 202B reflects off of facet 302A to generate optical path 124D in a partially upward direction (i.e., out from the page in the positive z direction). As rotating mirror 206 rotates around axis of rotation 306 in the direction indicated by arrow 307, the laser beam from laser unit 202A scans across optical path 124C in the direction indicated by an arrow 412C, and the laser beam from laser unit 202B scans across optical path 124D in the direction indicated by an arrow 412D.

During the third time period (not shown in FIGS. 4A and 4B), the laser beam from laser unit 202A reflects off of facet 302B to generate optical path 124A in a partially upward direction (i.e., out from the page in the positive z direction), and the laser beam from laser unit 202B reflects off of facet 304A to generate optical path 124B in a partially downward direction (i.e., into the page in the negative z direction). As rotating mirror 206 rotates around axis of rotation 306 in the direction indicated by arrow 307, the laser beam from laser unit 202A scans across optical path 124A in the direction indicated by arrow 412A, and the laser beam from laser unit 202B scans across optical path 124B in the direction indicated by arrow 412B.

During the fourth time period (not shown in FIGS. 4A and 4B), the laser beam from laser unit 202A reflects off of facet 304B to generate optical path 124C in a partially downward direction (i.e., into the page in the negative z direction), and the laser beam from laser unit 202B reflects off of facet 302B to generate optical path 124D in a partially upward direction (i.e., out from the page in the positive z direction). As rotating mirror 206 rotates around axis of rotation 306 in the direction indicated by arrow 307, the laser beam from laser unit 202A scans across optical path 124C in the direction indicated by arrow 412C, and the laser beam from laser unit 202B scans across optical path 124D in the direction indicated by arrow 412D.

In one embodiment, the operation of laser scanner assembly 122 described for the first through fourth time periods repeats continuously. In other embodiments where rotating mirror 206 includes another even number of facets, e.g., 6 or 8 facets, the operation of laser scanner assembly 122 may be described using a number of time periods equal to this even number.

During operation of laser scanner assembly 122, facets 304A and 304B of rotating mirror 206 cause the laser beam from laser unit 202B to scan across beam detector 420 as indicated by an arrow 416 that represents the laser beam from laser unit 202B scanning across beam detector 420. In response to detecting the laser beam, beam detector 420 generates a timing pulse that is used to provide feedback to a control circuit (not shown) to manage the operation of image forming system 100.

In one embodiment, beam detector 420 is offset from laser units 202A and 202B on circuit board 402 in the negative z direction such that the downward reflection of the laser beam caused by facets 304A and 304B allows the laser beam to scan across beam detector 420. In other embodiments, beam detector 402 may be mounted in other locations in image forming system 100.

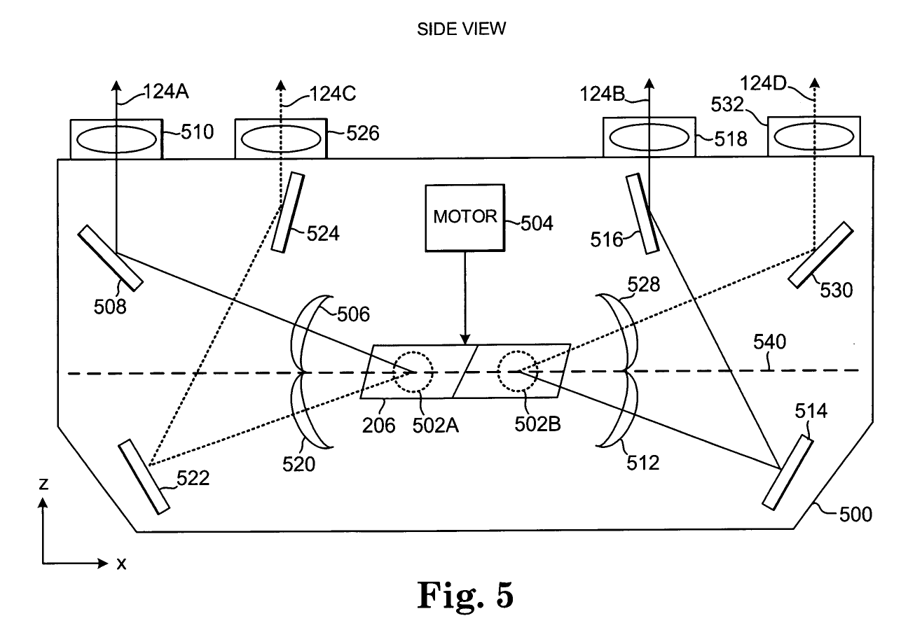

FIG. 5 is a diagram illustrating a side view of selected portions of one embodiment of laser scanner assembly 122. In the embodiment of FIG. 5, laser scanner assembly 122 includes a housing 500, a motor 504, rotating mirror 206, a lens 506, a reflective surface 508, a lens 510, a lens 512, a reflective surface 514, a reflective surface 516, a lens 518, a lens 520, a reflective surface 522, a reflective surface 524, a lens 526, a lens 528, a reflective surface 530, and a lens 532. In the embodiment of FIG. 5, lenses 510, 518, 526, and 532 are mounted outside housing 500 as shown.

In the embodiment of FIG. 5, motor 504 operates to rotate rotating mirror 206 in the x-y plane as the laser beam from laser unit 202A (not shown in FIG. 5) reflects off of rotating mirror 206 in a region 502A and the laser beam from laser unit 202B (not shown in FIG. 5) reflects off of rotating mirror 206 in a region 502B.

Referring to the time periods described above, region 502A occurs on facets 302A and 302B during the first and third time periods, respectively, to cause the laser beam from laser unit 202A to reflect off of rotating mirror 206 on optical path 124A. Along optical path 124A, the laser beam passes through lens 506, reflects off of reflective surface 508, and passes through lens 510. In one embodiment, lens 506, reflective surface 508, and lens 510 comprise optics 210 as shown in FIG. 2. Lens 506, reflective surface 508, and lens 510 collectively function to collimate and adjust the focal distance of the laser beam as the laser beam moves across photoconductor drum 104A. Lens 506, reflective surface 508, and lens 510 also collectively function to adjust the linear and angular velocities of the laser beam along optical path 124A to control the scan of the laser beam across photoconductor drum 104A.

In addition, region 502B occurs on facets 304B and 304A during the first and third time periods, respectively, to cause the laser beam from laser unit 202B to reflect off of rotating mirror 206 on optical path 124B. Along optical path 124B, the laser beam passes through lens 512, reflects off of reflective surfaces 514 and 516, and passes through lens 518. In one embodiment, lens 512, reflective surface 514, reflective surface 516, and lens 518 comprise optics 214 as shown in FIG. 2. Lens 512, reflective surface 514, reflective surface 516, and lens 518 collectively function to collimate and adjust the focal distance of the laser beam as the laser beam moves across photoconductor drum 104B. Lens 512, reflective surface 514, reflective surface 516, and lens 518 also collectively function to adjust the linear and angular velocities of the laser beam along optical path 124B to control the scan of the laser beam across photoconductor drum 104B.

During the second and fourth time periods, region 502A occurs on facets 304A and 304B, respectively, to cause the laser beam from laser unit 202A to reflect off of rotating mirror 206 on optical path 124C. Along optical path 124C, the laser beam passes through lens 520, reflects off of reflective surfaces 522 and 524, and passes through lens 526. In one embodiment, lens 520, reflective surface 522, reflective surface 524, and lens 526 comprise optics 212 as shown in FIG. 2. Lens 520, reflective surface 522, reflective surface 524, and lens 526 collectively function to collimate and adjust the focal distance of the laser beam as the laser beam moves across photoconductor drum 104C. Lens 520, reflective surface 522, reflective surface 524, and lens 526 also collectively function to adjust the linear and angular velocities of the laser beam along optical path 124C to control the scan of the laser beam across photoconductor drum 104C.

Further, region 502B occurs on facets 302A and 302B during the second and fourth time periods, respectively, to cause the laser beam from laser unit 202B to reflect off of rotating mirror 206 on optical path 124D. Along optical path 124D, the laser beam passes through lens 528, reflects off of reflective surface 530, and passes through lens 532. In one embodiment, lens 528, reflective surface 530, and lens 532 comprise optics 216 as shown in FIG. 2. Lens 528, reflective surface 530, and lens 532 collectively function to collimate and adjust the focal distance of the laser beam as the laser beam moves across photoconductor drum 104D. Lens 528, reflective surface 530, and lens 532 also collectively function to adjust the linear and angular velocities of the laser beam along optical path 124D to control the scan of the laser beam across photoconductor drum 104D.

As indicated by an axis 540 shown in the x-y plane in FIG. 5, optical paths 124A and 124D reflect off of rotating mirror 206 in a partially upward, i.e., positive z, direction, and optical paths 124B and 124C reflect off of rotating mirror 206 in a partially downward, i.e., negative z, direction.

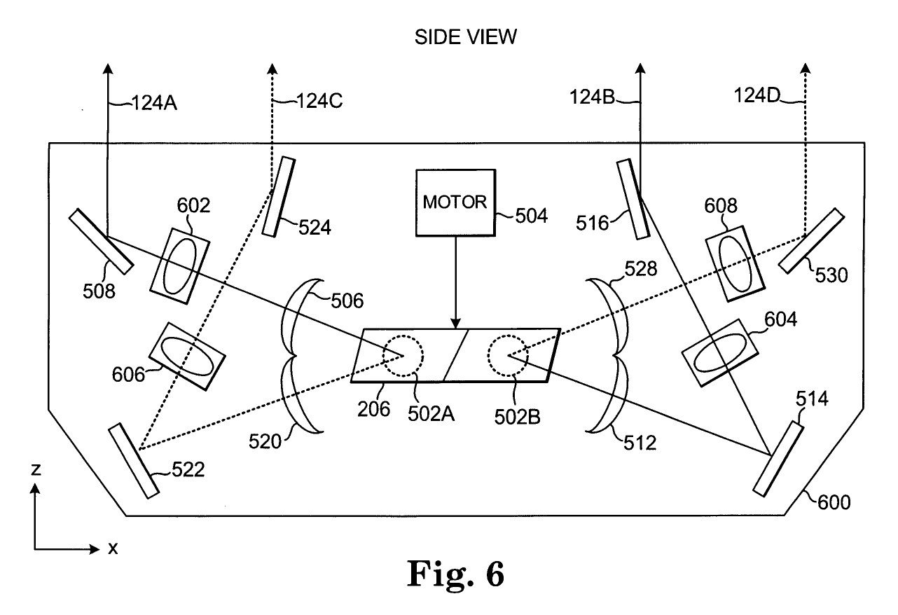

FIG. 6 is a diagram illustrating a side view of selected portions of one embodiment of laser scanner assembly 122. The embodiment of FIG. 6 functions similar to the embodiment shown in FIG. 5. In embodiment of FIG. 6, however, lenses 602, 604, 606, and 608 that are mounted inside a housing 600 replace lenses 510, 518, 526, and 532, respectively, that are mounted outside housing 500 in the embodiment of FIG. 5.

Along optical path 124A, the laser beam from laser unit 202A passes through lenses 506 and 602 and reflects off of reflective surface 508. In one embodiment, lenses 506 and 606 and reflective surface 508 comprise optics 210 as shown in FIG. 2. Lenses 506 and 606 and reflective surface 508 collectively function to collimate and adjust the focal distance of the laser beam as the laser beam moves across photoconductor drum 104A. Lenses 506 and 606 and reflective surface 508 also collectively function to adjust the linear and angular velocities of the laser beam along optical path 124A to control the scan of the laser beam across photoconductor drum 104A.

Along optical path 124B, the laser beam from laser unit 202B passes through lens 512, reflects off of reflective surface 514, passes through lens 604, and reflects off of reflective surface 516. In one embodiment, lenses 512 and 604 and reflective surfaces 514 and 516 comprise optics 214 as shown in FIG. 2. Lenses 512 and 604 and reflective surfaces 514 and 516 collectively function to collimate and adjust the focal distance of the laser beam as the laser beam moves across photoconductor drum 104B. Lenses 512 and 604 and reflective surfaces 514 and 516 also collectively function to adjust the linear and angular velocities of the laser beam along optical path 124B to control the scan of the laser beam across photoconductor drum 104B.

Along optical path 124C, the laser beam from laser unit 202A passes through lens 520, reflects off of reflective surface 522, passes through lens 606, and reflects off of reflective surface 524. In one embodiment, lenses 520 and 606 and reflective surfaces 522 and 524 comprise optics 212 as shown in FIG. 2. Lenses 520 and 606 and reflective surfaces 522 and 524 collectively function to collimate and adjust the focal distance of the laser beam as the laser beam moves across photoconductor drum 104C. Lenses 520 and 606 and reflective surfaces 522 and 524 also collectively function to adjust the linear and angular velocities of the laser beam along optical path 124C to control the scan of the laser beam across photoconductor drum 104C.

Along optical path 124D, the laser beam from laser unit 202B passes through lenses 528 and 608 and reflects off of reflective surface 530. In one embodiment, lenses 528 and 608 and reflective surface 530 comprise optics 216 as shown in FIG. 2. Lenses 528 and 608 and reflective surface 530 collectively function to collimate and adjust the focal distance of the laser beam as the laser beam moves across photoconductor drum 104D. Lenses 528 and 608 and reflective surface 530 also collectively function to adjust the linear and angular velocities of the laser beam along optical path 124D to control the scan of the laser beam across photoconductor drum 104D.

In other embodiments, facets 302A, 302B, 304A, and 304B of rotating mirror 206 may each have different angles θ₁ and θ₂ as described above with reference to FIGS. 3A-3D such that facets 302A, 302B, 304A, and 304B are configured to direct one or more laser beams (e.g., four laser beams) to photoconductor drums 104A, 104B, 104C, and 104D, respectively. In these embodiments, photoconductor drums 104A, 104B, 104C, and 104D are written sequentially.

In other embodiments, rotating mirror 206 may include other even numbers of facets (e.g., 6 or 8 facets) where each facet has an angle that is configured to direct one or more laser beams to the same or other numbers of photoconductor drums 104.

The above embodiments may maintain the speed of generating and transferring images in an image forming system while decreasing the number or cost of components in the system. For example, compared to a system that includes a rotating mirror for each laser unit, at least one rotating mirror and accompanying optics may be omitted by using embodiments of the rotating mirror described above. In addition, a scan line time, i.e., a beam detect period, and the dot rate or laser beam power of the laser units may be the same as embodiments that include two or more rotating mirror assemblies.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A laser scanner assembly comprising:
a rotating mirror;
a first laser unit configured to generate at least a first laser beam; and
a second laser unit configured to generate at least a second laser beam;
wherein the rotating mirror is configured to direct the first laser beam along a first optical path during a first time period and along a second optical path during a second time period that is subsequent to the first time period, and wherein the rotating mirror is configured to direct the second laser beam along a third optical path during the first time period and along a fourth optical path during the second time period.

2. The laser scanner assembly of claim 1 wherein the rotating mirror includes at least first, second, third, and fourth facets.

3. The laser scanner assembly of claim 2 wherein the first facet directs the first laser beam along the first optical path during the first time period, wherein the second facet directs the first laser beam along the second optical path during the second time period, wherein the third facet directs the second laser beam along the third optical path during the first time period, and wherein the first facet directs the second laser beam along the fourth optical path during the second time period.

4. The laser scanner assembly of claim 3 wherein the fourth facet directs the first laser beam along the first optical path during a third time period that is subsequent to the second time period, wherein the third facet directs the first laser beam along the second optical path during a fourth time period that is subsequent to the third time period, wherein the second facet directs the second laser beam along the third optical path during the third time period, and wherein the fourth facet directs the second laser beam along the fourth optical path during the fourth time period.

5. The laser scanner assembly of claim 1 wherein the first optical path is directed onto a first photoconductor drum, wherein the second optical path is directed onto a second photoconductor drum, wherein the third optical path is directed onto a third photoconductor drum, and wherein the fourth optical path is directed onto a fourth photoconductor drum.

6. The laser scanner assembly of claim 5 wherein the first, the second, the third, and the fourth photoconductor drums are configured to receive first, second, third, and fourth color toners, respectively.

7. The laser scanner assembly of claim 5 further comprising:
first optics along the first optical path between the rotating mirror and the first photoconductor drum;
second optics along the second optical path between the rotating mirror and the second photoconductor drum;
third optics along the third optical path between the rotating mirror and the third photoconductor drum; and
fourth optics along the fourth optical path between the rotating mirror and the fourth photoconductor drum.

8. The laser scanner assembly of claim 1 further comprising:
at least a first lens between the first laser unit and the rotating mirror; and
at least a second lens between the second laser unit and the rotating mirror.

9. The laser scanner assembly of claim 1 further comprising:
an imaging unit configured to control the operation of the first laser unit and the second laser unit.

10. The laser scanner assembly of claim 1 wherein the first laser unit is configured to generate at least a third laser beam, wherein the second laser is configured to generate at least a fourth laser beam, wherein the rotating mirror is configured to direct the first and the third laser beams along the first optical path during the first time period and along the second optical path during the second time period, and wherein the rotating mirror is configured to direct the second and the fourth laser beams along the third optical path during the first time period and along the fourth optical path during the second time period.

11. A rotating mirror comprising:
a first facet configured to direct a first laser beam along a first optical path during a first time period and a second laser beam along a second optical path during a second time period;
a second facet configured to direct the first laser beam along a third optical path during the second time period and the second laser beam along a fourth optical path during a third time period;
a third facet configured to direct the first laser beam along the first optical path during the third time period and the second laser beam along the second optical path during a fourth time period; and
a fourth facet configured to direct the first laser beam along the third optical path during the fourth time period and the second laser beam along the fourth optical path during the first time period.

12. The rotating mirror of claim 11 further comprising:
an axis of rotation; and
wherein the first facet includes a first outer edge and a first inner edge relative to the axis of rotation, wherein the first facet forms a first angle between the axis of rotation and a first hypothetical plane that is parallel to the axis of rotation and is parallel to and intersects the first outer edge, and wherein the first angle is between positive ninety degrees and negative ninety degrees.

13. The rotating mirror of claim 12 wherein the second facet includes a second outer edge and a second inner edge relative to the axis of rotation, wherein the second facet forms a second angle between the axis of rotation and a second hypothetical plane that is parallel to the axis of rotation and is parallel to and intersects the second outer edge, wherein the second angle is between positive ninety degrees and negative ninety degrees, and wherein the second angle is not equal to a negative of the first angle.

14. The rotating mirror of claim 13 wherein the third facet includes a third outer edge and a third inner edge relative to the axis of rotation, wherein the third facet forms a third angle between the axis of rotation and a third hypothetical plane that is parallel to the axis of rotation and is parallel to and intersects the third outer edge, wherein the third angle is between positive ninety degrees and negative ninety degrees, and wherein the third angle is not equal to a negative of the second angle.

15. The rotating mirror of claim 14 wherein the fourth facet includes a fourth outer edge and a fourth inner edge relative to the axis of rotation, wherein the fourth facet forms a fourth angle between the axis of rotation and a fourth hypothetical plane that is parallel to the axis of rotation and is parallel to and intersects the fourth outer edge, wherein the fourth angle is between positive ninety degrees and negative ninety degrees, and wherein the fourth angle is not equal to a negative of the first angle or a negative of the third angle.

16. The rotating mirror of claim 15 wherein the first angle is equal to the third angle, and wherein the second angle is equal to the fourth angle.

17. An image forming system comprising:
first, second, third, and fourth photoconductor drums;
a rotating mirror; and
first and second laser units configured to generate first and second laser beams, respectively;
wherein the rotating mirror is configured to direct the first laser beam onto the first photoconductor drum during a first time period and onto the third photoconductor drum during a second time period that is subsequent to the first time period, and wherein the rotating mirror is configured to direct the second laser beam onto the second photoconductor drum during the first time period and onto the fourth photoconductor drum during the second time period.

18. The image forming system of claim 17 further comprising:
an imaging unit configured to cause the first laser unit and the second laser unit to selectively generate the first and the second laser beams, respectively, during the first and the second time periods.

19. The image forming system of claim 17 further comprising:
first, second, third, and fourth toner units configured to transfer first, second, third, and fourth toners to the first, the second, the third, and the fourth photoconductor drums, respectively; and
an image transfer system configured to cause the first, the second, the third, and the fourth toners to be transferred from the first, the second, the third, and the fourth photoconductor drums, respectively, to a medium.

20. The image forming system of claim 17 further comprising:
a motor configured to rotate the rotating mirror about an axis during the first and the second time periods.
